(19) United States
(12) Patent Application Publication
(10) Pub. No.: US 2003/0058807 A1
(43) Pub. Date: Mar. 27, 2003

(54) Method and device for echo cancellation in a telecommunication network

(76) Inventor: Klaus Hoffmann, Munchen (DE)

Correspondence Address: Morrison & Foerster LLP, Suite 300, 1650 Tysons Boulevard, McLean, VA, 22102, US

(21) Appl. No.: 10/223,704

(22) Filed: Aug. 20, 2002

(30) Foreign Application Priority Data
Aug. 21, 2001 (DE) 10140870.6

(51) Int. Cl. H04B 3/20

(52) U.S. Cl. 370/286; 379/406.01

(57) ABSTRACT

The invention relates to a system and method for echo cancellation in a telecommunication network in which a user information channel connection is effected via a packet-oriented data network between a first and a second media gateway and a media gateway controller is provided for controlling the first media gateway. According to the invention, an echo cancellation is activated on demand in the user information channel connection.

### CLAIM FOR PRIORITY

This application claims priority to German Application No. 10140870.6 which was filed in the German language on Aug. 21, 2001.

### TECHNICAL FIELD OF THE INVENTION

The invention relates to a system and method for echo cancellation in a telecommunication network.

### BACKGROUND OF THE INVENTION

Communication architectures which utilize packet- or cell-based methods for transmitting voice signals such as, for example, Voice over IP (VoIP) or Voice over ATM (VOATM) provide for the separation of the signalling and the switching of a communications link, on the one hand, from the transport of user information, on the other hand.

In practice, switching networks are divided into call service related units (call feature server) and transport of the user information (bearers) and units for controlling these user traffic connections (bearer control). To provide for communication with conventional circuit-switched telecommunication networks or PSTNs, respectively (public switched telephone networks), a translation is required between these two different communication architectures.

Different transport technologies, especially high-bit-rate technologies such as VoIP or VOATM, are used for transmitting the user information in the packet-oriented data networks. Accordingly, a backbone based on the IP (Internet Protocol) or on ATM (asynchronous transfer mode) is used as a remote network for transmitting voice signals between terminals. As a rule, signalling information is transported together with the user data. For this purpose, each data packet exhibits user data, particularly in the packet header, and information controlling the transport, i.e. signalling information. This signalling information is, for example, the IP address of a receiver.

However, the signalling can also take place via the IP/ATM backbone, independently of the bearer. The aim of this division into signalling and user information is the reuse of the telecommunication services of the current narrow-band networks in broadband networks. Above all, this makes it possible for subscribers to be connected to so-called call feature servers (CSF), either directly via, for example, the DSS1 (digital signalling system No. 1) or via switching centers, for example in accordance with ISUP (ISDN User Part). Such call feature servers separate user data from signalling information and thus make it possible to couple packet-oriented data networks to conventional circuit-switched telecommunication networks.

At the coupling point, the user traffic connections are converted into the transport technology used by means of special servers called media gateways (MG). Media gateways have both interfaces to PSTN/ISDN networks and to IP/ATM networks and thus form the interfaces between circuit-switched and packet-oriented networks. They can convert TDM (time division multiplex) voice data into VoIP/VoATM data and conversely in real time. As a rule, they can only convert the information required for setting up simple connections, apart from this conversion.

The media gateways are, therefore, controlled by central entities, the media gateway controllers (MGC). These are essentially used for coordinating media gateways and monitor and control connections between media gateways. The media gateway controllers also operate as call feature servers in order to enable continuing telecommunication services to set up simple connections. Control is effected on the basis of the MGCP (media gateway controller protocol) or the H.248 protocol or Q.1950 protocol.

To communicate with one another, the call feature servers use an extended ISUP protocol (ISUP+) or the standardized BICC (bearer independent call control) protocol. At present, there are the ITU standards Q.1902.x BICC CS2 (bearer independent call control capability set 2, with a separate service indicator in the MTP (message transfer part)) and Q.765.5 BAT (bearer application transport). These describe the RTP (real time protocol) as bearer technology for IP bearers, i.e. IP-based data networks, and how a subscriber is to be provided with services which he knows from the conventional circuit-switched networks.

FIG. 1 shows the connection of two PSTNs 10 and 12 via a packet-oriented data network 20, in this case the Internet. The two PSTNs (public switched telephone networks) 10 and 12 in each case have local exchanges (LE) to which telephones 14 are connected as terminals, and a gateway TX 16 and 18, respectively, to the data network 20 used as trunk communication network. The gateways TX 16 and 18 are in each case connected both to a media gateway controller 26 and 28, respectively, and to a media gateway 22 and 24, respectively.

The media gateways 22 and 24 are directly connected to the Internet 20 as IP bearer. They are essentially used for packetizing and depacketizing data packets which are received or transmitted via the Internet 20. The data packets are used for transmitting the user information of a connection between the two PSTNs 10 and 12. Connection control is effected via the media gateway controllers 26 and 28 which exchange information by means of BICC CS2 or ISUP+. The ISUP protocol is used for common channel signalling (CCS) between the gateways TX 16 and 18 and the media gateway controllers 26 and 28, respectively.

However, it is possible, particularly in the case of VoIP connections between media gateways, that delays occur which are of such magnitude that echo cancellation becomes necessary in order to obtain a voice connection of sufficiently high quality. At present, it is assumed that echo cancellation is always necessary in a VoIP connection, for example in the media gateways forming IP end points. As a rule, a fixed delay is assumed, therefore, and the echo cancellation is set up in accordance with this delay. If echo cancellation is permanently active, however, it requires additional expenditure.

### SUMMARY OF THE INVENTION

The invention is discloses a system and method of reducing the expenditure required by the echo cancellation in telecommunication networks.

The invention is a dynamic non-static utilization or demand-activation of echo cancellation. The invention recognizes that, contrary to previous assumptions, echo cancellation is not always required.

The previous assumption is mainly based on the current configuration of packet-oriented data networks, such as the Internet, but does not take into consideration that a rapidly advancing extension of such data networks is expected in the future due to the increasing volume of data transmissions. The quality of service (QOS) of voice connections via these data networks will also increase. The invention therefore discloses activating an echo cancellation when it is required. This enables the operators of such telecommunication networks to utilize existing resources, particularly resources for echo cancellation, in the most cost-effective manner.

In one embodiment of the invention, there is a method for echo cancellation in a telecommunication network in which a user information channel connection is effected via a packet-oriented data network between a first and a second media gateway. A media gateway controller is provided which controls at least the first MG. In the case of a voice connection, the echo cancellation is activated on demand when required because the delay of data packets via a packet-oriented data network is large. The echo cancellation is preferably switched on when the delay of data packets exceeds a predetermined threshold value.

In one aspect of the invention, during the existence of the user channel connection, a jitter buffer and a device for detecting the so-called roundtrip delay perform as a delay measuring device for the user channel connection and, when a predetermined propagation delay is exceeded, a message is sent out and, if necessary, the echo cancellation is activated. The length of the jitter buffer is included in this in addition to one half of the current roundtrip so that delay monitoring is possible by observing the jitter buffer. The detection of the current delay value is initiated, in particular, in an “encapsulated notification request” with the RTP package.

For MGCP, the following event in the RTP package is proposed again:

Package Name: R

Symbol Definition R S Duration PD(###) Propagation delay exceeded X

Propagation delay exceeded: the MG is requested to report the actual delay (###) (in ms) to the MGC starting with a delay ### (in ms). The propagation delay is composed of half the roundtrip and the jitter buffer.

When a communication between MGC and MG is used, echo cancellers can be switched on dynamically when required, either locally or remotely on the basis of MGCP or H.248 by using ISUP (ISDN User Part, Q.761-Q.764) and possibly BICC and ISUP+.

In another aspect of the invention, before activation of an echo cancellation and at the beginning of setting up the user channel connection, a measurement of the roundtrip delay between the first and the second MG is performed in a preferred embodiment of the method, in order to determine the (initial) delay of data packets on the user information channel connection. After this initial measuring process, the delay measurements are continued continuously during the data transmission.

Apart from using BICC as protocol for the communication between MGCs, ISUP+ can also be used. In addition to MGCP, H.248 can be used as protocol for the communication between MGC and MG, particularly after a corresponding extension of the protocol.

The method is not restricted to the preferred RTP bearer as bearer protocol but, in principle, can also be applied to other bearer technologies.

In another embodiment of the invention, there is a device for echo cancellation in a network, in which a user information channel connection exists via a packet-oriented data network between a first and a second MG and an MGC is provided which controls at least the first MG, and has a control device for the demand-activation of an echo cancellation in the user information channel connection. The control device can be constructed as software or as hardware. The control device is preferably part of the MGC.

In one embodiment of the control device, a component of the echo cancellation control device is a comparator unit which receives delay measurement values via a message from the MG via a first input (measurement signal input) and is connected to a delay threshold store for storing a pre-programmed delay threshold value via a second input (reference signal input). As a result of the comparison of the current delay with the delay threshold value pre-stored as reference, the comparator unit outputs a control signal which causes the echo canceller to become activated or to remain inactive.

As the “delay measuring device”, in one embodiment, at least one media gateway can have at least one jitter buffer in which data packets of the user information channel connection are temporarily stored. The length of the jitter buffer can then be used—together with the above-mentioned roundtrip delay—as the criterion for the decision about sending out a message (NTF). It describes the variance of the arrival of packets at a point of reception and forms the first summand of a propagation delay in which half of the current roundtrip (as determined via the time stamps in RFC1889, chapter 6.3.1) is included as second summand.

### BRIEF DESCRIPTION OF THE DRAWINGS

In the text which follows, the invention will be explained with reference to the exemplary embodiments and in connection with the drawings, in which:

FIG. 1 shows a prior art telecommunication network in which voice signals are transmitted in a packet-oriented manner and signalling and switching of user information transport are separated.

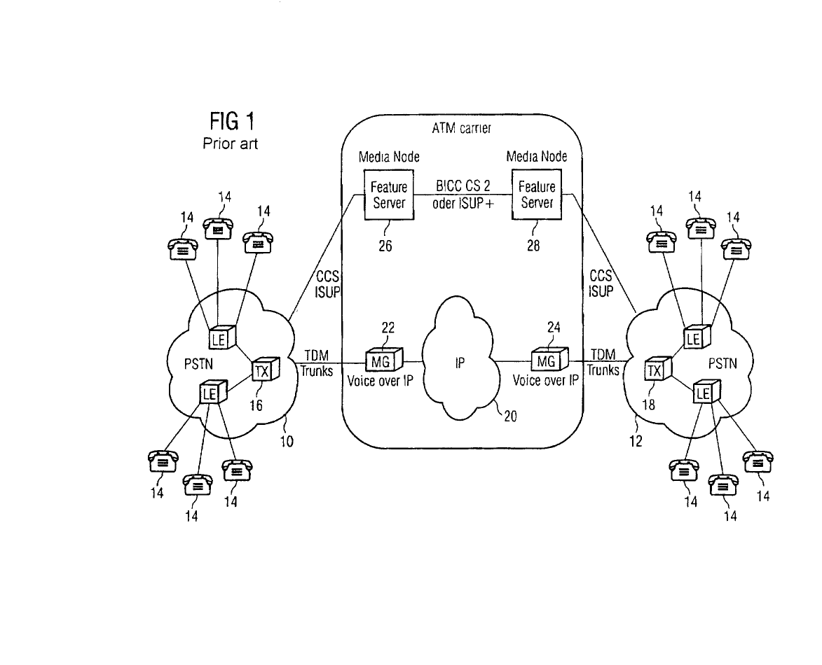

FIG. 2 shows an exemplary embodiment of a telecommunication network in which signalling and switching of user information transport are separated according to the invention.

In the text which follows, the same reference symbols can be used for identical elements and for elements having identical functionalities. Reference is made to the list of reference symbols and abbreviations in order to explain the abbreviations used.

### DETAILED DESCRIPTION OF THE PREFERRED EMBODIMENT

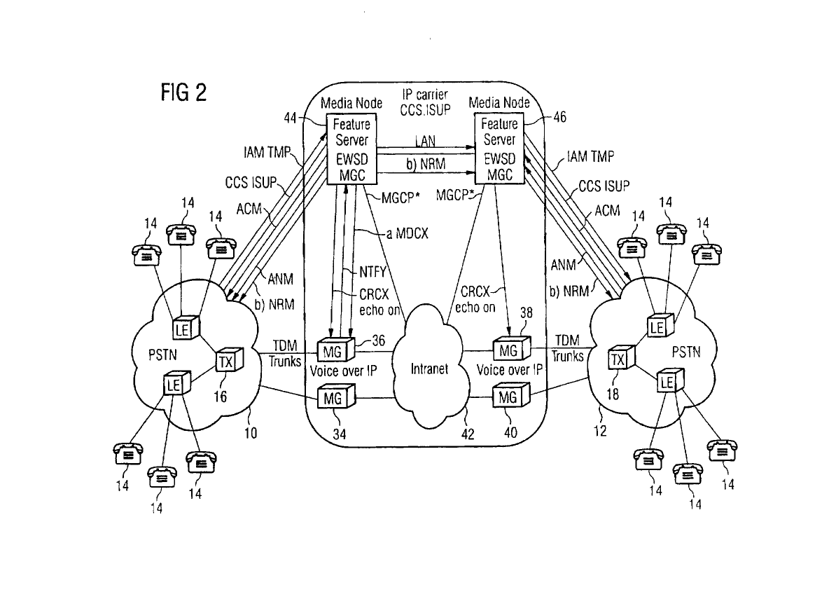

The basic sequences of the method according to the invention can be found in FIG. 2, where the acknowledgement messages from MGCP have not been reproduced for the sake of clarity. Aspects of the application of switching on the echo cancellers are discussed, but not the basic setting up of a connection which is assumed to be known by those skilled in the art.

FIG. 2 shows a telecommunication network which has two PSTNs 10 and 12 which can communicate with one another via a packet-oriented data network 42, in this case an intranet (the networks can be two telecommunication networks of a company at different sites). To provide for inexpensive voice communication between the sites, voice connections are carried out by VoIP between the PSTN 10 and PSTN 12. Hence, conventional circuit-switched communication takes place in the PSTNs 10 and 12, whereas voice signals are inexpensively transmitted in a packet-oriented manner in the data network 42 as trunk network.

The PSTNs 10 and 12 in each case have local exchanges LE and a gateway TX 16 and 18, respectively. At the local exchanges LE, telephones 14 are connected as terminals for voice communication. The gateways TX 16 and 18 are used for coupling the PSTNs 10 and 12 to the packet-oriented data network 42.

The media gateways 34, 36, 38 and 40 provide a gateway from a circuit-switched voice connection to a packet-oriented voice connection. For this purpose, the media gateways 34, 36 and 38, 40 are connected to the gateways 16 and 18, respectively, of the PSTNs 10 and 12, respectively.

FIG. 2 also shows the control of the media gateways 36 and 38 via media gateway controllers or call feature servers 44 and 46, respectively. Media gateway controllers or call feature servers 44 and 46, respectively, can be constructed as units of one or more conventional switching systems, for example as special plug-in cards.

When the message “IAM” of the ISUP or BICC/ISUP+ is received in the two media gateway controllers 44 and 46, the message “CRCX” (create connection) of the MGCP* is in each case sent, after evaluation of the TMR, with the note of not switching on echo cancellers; at the same time, the detection of changes is activated in the new proprietary MGCP “requested event” “propagation delay exceeded” in the media gateway 36 in the “encapsulated notification request” with the RTP package.

If the media gateway 38 detects later that the buffer is becoming larger, it reports this event to the media gateway controller 44 by means of an NTFY. In the media gateway controller 44, an investigation is then performed whether the size of the buffer exceeds the recommended delay starting from which the echo cancellers should be switched on, for instance.

In accordance with the signalling network in which the media gateway controller 44 is located, it can then either switch on the echo canceller locally with the aid of the message “MDCX” 50 of the MGCP in its own media gateway 36 or activate an echo canceller located further away towards the end points of the voice connection defined by the media gateways 36 and 38 or even on the other side of these end points via the “enhanced echo control procedure” according to chapter 2.7.2 of the ITUT standard Q.764, with the aid of the message “NRM” (network resource management) via ISUP and/or BICC or ISUP+.

The echo cancellers are thus activated if the delays of an existing voice connection become too large. If the procedure triggered by the message “NRM” were not used (that is to say local switch-on only), it cannot be prevented that a number of echo cancellers are inserted when TDM-IP-TDM IP connections are connected in cascade.

1. A method for echo cancellation in a telecommunication network, comprising:
establishing a user information channel connection via a packet-oriented data network between a first and a second media gateway; and
providing a controller for controlling the first media gateway such that an echo cancellation is activated on demand in the user information channel connection.

2. The method as claimed in claim 1, wherein the echo cancellation is activated based on a delay detection if the delay of data packets exceeds a predetermined threshold value.

3. The method as claimed in claim 2, wherein during the existence of the user information channel connection, when a transgression of a predetermined amount of a delay time which is a result of a length of a jitter buffer and half the current roundtrip is observed, a message is delivered to the controller and optionally activates the echo cancellation locally and/or remotely.

4. The method as claimed in claim 1, wherein when communication occurs between the controller and the media gateway, at least one echo cancellation is activated locally or remotely by dynamically applying ISUP and BICC or ISUP+, respectively.

5. The method as claimed in claim 1, wherein when setting up the user information channel connection and before activation of the echo cancellation, a measurement of a roundtrip delay between the first and second media gateway is performed to determine the delay of data packets in the user information channel connection.

6. The method as claimed in claim 1, wherein an RTP bearer or ATM bearer is used as bearer protocol.

7. The method as claimed in claim 1, wherein H.248 or MGCP or Q.1950 is used as protocol for the communication between the media gateway controller and the media gateway.

8. The method as claimed in claim 2, wherein a transgression of the predetermined delay threshold is reported in an information element of an NTFY.

9. The method as claimed in claim 8, wherein TMRs are evaluated in the controller and control signals are generated for the activation or the non-activation of the echo cancellation based on a result of the evaluation.

10. A device for echo cancellation in a telecommunication network, comprising:
a user information channel connection established via a packet-oriented data network between a first and a second media gateway; and
a controller for controlling the first media gateway having an echo cancellation control device for activating an echo canceller on demand in the user information channel connection.

11. The device as claimed in claim 10, wherein the echo cancellation control device has a threshold value store for storing a predetermined delay threshold value and a comparator unit, which is connected to its input and receives current delay measurement values, for comparing a measured delay value with a stored threshold value and for outputting an output signal representing the results of the comparison.

12. The device as claimed in claim 11, wherein the delay measuring device has a jitter buffer and a device for measuring the roundtrip delay.
